(19) United States
(12) Patent Application Publication
(10) Pub. No.: US 2023/0196026 A1
(43) Pub. Date: Jun. 22, 2023

(54) Method for Evaluating Text Content, and Related Apparatus

(71) Applicant: Beijing Baidu Netcom Science Technology Co., Ltd., Beijing (CN)

(72) Inventors: Xiyang WANG, Beijing (CN); Ruiqing ZHANG, Beijing (CN); Zhongjun HE, Beijing (CN); Zhi LI, Beijing (CN); Hua WU, Beijing (CN)

(21) Appl. No.: 18/109,813

(22) Filed: Feb. 14, 2023

(30) Foreign Application Priority Data
May 19, 2022 (CN) 202210553070.4

(51) Int. Cl. G06F 40/30; G06F 40/289

(52) U.S. Cl. CPC G06F 40/30; G06F 40/289

(57) ABSTRACT

A method for evaluating a text content, which may include: after splitting a to-be-evaluated text into a plurality of clauses arranged in sequence according to punctuation information of the to-be-evaluated text, determining a first clause of the plurality of clauses as an actual tune name; then, determining actual prosodic information based on a Chinese phonetic alphabet text of a third clause to a last clause in response to that a number of clauses, whose numbers of Chinese characters satisfy character count requirements of clauses corresponding to the actual tune name, from the third clause to the last clause exceeds a number threshold; and finally, in response to the actual prosodic information being consistent with a standard prosodic information of the actual tune name, evaluating the to-be-evaluated text as a Ci-poetry text.

### CROSS-REFERENCE TO RELATED APPLICATIONS

The present application claims the priority of Chinese Patent Application No. 202210553070.4, titled “Method for Evaluating Text Content, Related Apparatus, and Computer Program Product”, filed on May 19, 2022, the content of which is incorporated herein by reference in its entirety.

### TECHNICAL FIELD

The present disclosure relates to the field of computer technology, particularly to the field of artificial intelligence such as text evaluation, text classification, natural language processing and the like, and more particularly to a method and apparatus for evaluating a text content, an electronic device, and a computer readable storage medium.

### BACKGROUND

Ci-poetry is a kind of poetry, sprouting from Southern Dynasties, which is a new literary style rising in Sui and Tang Dynasties. In Song Dynasty, after a long period of continuous development, the Ci-poetry entered a full-blooming period, the Ci-poetry is a new poetic form compared to an ancient poetry, and occupies a very important position in ancient Chinese literature. The Ci-poetry have a profound impact on Chinese culture with their succinct language, elegant rhythm and rich content, and even in modern times, the Ci-poetry is still loved by people.

With the development of artificial intelligence technology, users have begun to try to use artificial intelligence technology to generate a wide variety of texts, for example, try to automatically generate Ci-poetry of the Song dynast by using a pre-trained machine learning model under given keywords.

### SUMMARY

Embodiments of the present disclosure provide a method and apparatus for evaluating a text content, an electronic device, and a computer readable storage medium.

According to a first aspect, an embodiment of the present disclosure provides a method for evaluating a text content. The method may include: splitting a to-be-evaluated text into a plurality of clauses arranged in sequence according to punctuation information of the to-be-evaluated text; determining a first clause of the plurality of clauses as an actual tune name; determining actual prosodic information based on a Chinese phonetic alphabet text of a third clause to a last clause in response to determining that a number of clauses, whose numbers of Chinese characters satisfy character count requirements of clauses corresponding to the actual tune name, from the third clause to the last clause exceeds a number threshold; and in response to the actual prosodic information being consistent with a standard prosodic information of the actual tune name, evaluating the to-be-evaluated text as a Ci-poetry text.

According to a second aspect, an embodiment of the present disclosure provides an apparatus for evaluating a text content. The apparatus may include: a text splitting unit, configured to split a to-be-evaluated text into a plurality of clauses arranged in sequence according to punctuation information of the to-be-evaluated text; a tune name determining unit, configured to determine a first clause of the plurality of clauses as an actual tune name; a prosodic information determining unit, configured to determine actual prosodic information based on a Chinese phonetic alphabet text of a third clause to a last clause in response to that a number of clauses, whose numbers of Chinese characters satisfy character count requirements of clauses corresponding to the actual tune name, from the third clause to the last clause exceeds a number threshold; and a first Ci-poetry text evaluation unit, configured to, in response to the actual prosodic information being consistent with a standard prosodic information of the actual tune name, evaluate the to-be-evaluated text as a Ci-poetry text.

In a third aspect, an embodiment of the present disclosure provides an electronic device including at least one processor; and a memory communicatively connected to the at least one processor. The memory stores instructions executable by the at least one processor, and the instructions, when executed by the at least one processor, cause the at least one processor to perform the method for evaluating a text content as described in any implementation of the first aspect.

In a fourth aspect, an embodiment of the present disclosure provides a non-transitory computer readable storage medium storing computer instructions. The computer instructions are used to cause the computer to perform the method for evaluating a text content as described in any implementation of the first aspect.

According to the method and apparatus for evaluating a text content, the electronic device, the computer readable storage medium, and the computer program product provided in the embodiment of the present disclosure, a to-be-evaluated text is split into a plurality of clauses arranged in sequence according to punctuation information of the to-be-evaluated text, a first clause of the plurality of clauses is determined as an actual tune name; then, actual prosodic information is determined based on a Chinese phonetic alphabet text of a third clause to a last clause in response to that a number of clauses, whose numbers of Chinese characters satisfy character count requirements of clauses corresponding to the actual tune name, from the third clause to the last clause exceeds a number threshold; and finally, in response to the actual prosodic information being consistent with a standard prosodic information of the actual tune name, the to-be-evaluated text is evaluated as a Ci-poetry text.

After the to-be-evaluated text is split, embodiments of the disclosure determine information that exists in the to-be-evaluated text and is used as the tune name, and performs prosodic matching on the to-be-evaluated text by using standard prosodic information corresponding to the actual tune name, thereby realizing the recognition of the Ci-poetry text.

It should be understood that contents described in this section are neither intended to identify key or important features of embodiments of the present disclosure, nor intended to limit the scope of the present disclosure. Other features of the present disclosure will become readily understood in conjunction with the following description.

### BRIEF DESCRIPTION OF THE DRAWINGS

Other features, objects, and advantages of the present disclosure will become more apparent by reading the detailed description of non-limiting embodiments made with reference to the following drawings:

FIG. 1 is an exemplary system architecture in which embodiments of the present disclosure may be applied;

FIG. 2 is a flowchart of a method for evaluating a text content according to an embodiment of the present disclosure;

FIG. 3 is a flowchart of another method for evaluating a text content according to an embodiment of the present disclosure;

FIG. 4 is a schematic flowchart of the method for evaluating a text content in an application scenario according to an embodiment of the present disclosure;

FIG. 5 is a structural block diagram of an apparatus for evaluating a text content according to an embodiment of the present disclosure;

FIG. 6 is a schematic structural diagram of an electronic device suitable for performing the method for evaluating a text content according to an embodiment of the present disclosure.

### DETAILED DESCRIPTION

Example embodiments of the present disclosure are described below with reference to the accompanying drawings, where various details of the embodiments of the present disclosure are included to facilitate understanding, and should be considered merely as examples. Therefore, those of ordinary skills in the art should realize that various changes and modifications can be made to the embodiments described here without departing of the scope and spirit of the present disclosure. Similarly, for clearness and conciseness, descriptions of well-known functions and structures are omitted in the following description.

In addition, in the technical solution related to the present disclosure, the processes of acquiring, storing, using, processing, transporting, providing, and disclosing the personal information of the user all comply with the provisions of the related laws and regulations, and do not violate the public order and good customs.

FIG. 1 illustrates an exemplary system architecture 100 to which embodiments of a method and apparatus for evaluating a text content, an electronic device, and a computer readable storage medium of the present disclosure may be applied.

As shown in FIG. 1, the system architecture 100 may include terminal devices 101, 102, 103, a network 104, and a server 105. The network 104 serves as a medium for providing a communication link between the terminal devices 101, 102, 103 and the server 105. The network 104 may include various types of connections, such as wired, wireless communication links, or fiber optic cables, and the like.

The user may interact with the server 105 through the network 104 using the terminal devices 101, 102, 103 to receive or send messages, etc. The terminal devices 101, 102, 103 and the server 105 may be provided with various applications for implementing information communication therebetween, such as Ci-poetry recognition applications, Ci-poetry evaluation applications, instant messaging applications, and the like.

The terminal devices 101, 102, 103 and the server 105 may be hardware or software. When the terminal devices 101, 102, 103 are hardware, they may be various electronic devices having a display screen, including but not limited to a smartphone, a tablet computer, a laptop computer, a desktop computer, and the like. When the terminal devices 101, 102, and 103 are software, the terminal devices 101, 102, and 103 may be installed in the electronic devices listed above, and may be implemented as a plurality of software or software modules, or may be implemented as a single software or software modules, which is not specifically limited herein. When the server 105 is hardware, a distributed server cluster composed of multiple servers may be implemented, or a single server may be implemented. When the server is software, the server may be implemented as a plurality of software or software modules, or may be implemented as a single software or software modules, which is not specifically limited herein.

The server 105 may provide various services through various built-in applications, for example, may provide a Ci-poetry recognition application that identifies whether the to-be-evaluated text is a Ci-poetry text. When the server 105 runs the Ci-poetry recognition application, the server 105 may achieve the following effects. First, after obtaining the to-be-evaluated text from the terminal devices 101, 102, and 103 through the network 104, the server 105 may split the to-be-evaluated text into a plurality of clauses arranged in sequence according to the punctuation information of the to-be-evaluated text; then, the server 105 determines the first clause of the plurality of clauses as the actual tune name; next, the server 105 responds when a number of clauses, whose numbers of Chinese characters satisfy character count requirements of clauses corresponding to the actual tune name, from the third clause to the last clause exceeds a number threshold, and determines actual prosodic information based on the Chinese phonetic alphabet texts of the third clause to the last clause. Finally, the server 105 responds when the actual prosodic information is consistent with the standard prosodic information of the actual tune name, and evaluates the to-be-evaluated text as a Ci-poetry text.

It should be noted that the to-be-evaluated text may be obtained from the terminal devices 101, 102, 103 through the network 104, or may be pre-stored locally on the server 105 in various manners. Thus, when the server 105 detects that the data has been stored locally (e.g., a to-be-processed text recognition task stored prior to the start of processing), the data may be obtained directly from the local, in which case the exemplary system architecture 100 may alternatively not include the terminal devices 101, 102, 103 and the network 104.

Since the storage of the standard prosodic information corresponding to the tune name requires more storage resources, and the generation of prosodic information based on the Chinese phonetic alphabet text and the comparison of prosodic information requires more computational power, the method for evaluating a text content provided in the subsequent embodiments of the present disclosure is generally performed by the server 105 having more computational power and more computational resources, and accordingly, the apparatus for evaluating a text content is also generally provided in the server 105. However, it should be noted that, when the terminal devices 101, 102, and 103 also have computational power and computational resources that satisfy the requirement, the terminal devices 101, 102, and 103 may complete the above computations handed over to the server 105 through the Ci-poetry recognition applications installed on the terminal devices 101, 102, and 103, and further output the same results as those of the server 105. In particular, in the case where a plurality of terminal devices having different computational power exist at the same time, when the terminal device in which the Ci-poetry recognition application determines that the terminal device has a relatively strong computational power and a relatively large amount of remaining computational resources, the terminal device may be enabled to perform the above-mentioned operations, so that the computing pressure of the server 105 is appropriately reduced. Accordingly, the text content evaluation apparatus may be provided in the terminal devices 101, 102, and 103. In this case, the exemplary system architecture 100 may also not include the server 105 and the network 104.

It should be understood that the number of the terminal devices, the networks and the servers in FIG. 1 is merely illustrative. There may be any number of the terminal devices, the networks and the servers as desired for implementation.

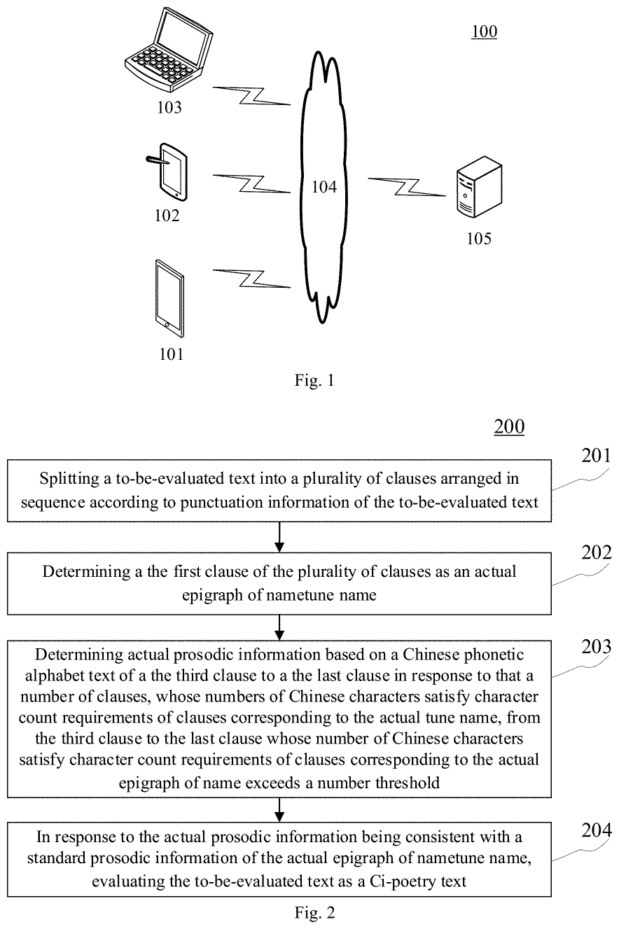

Referring to FIG. 2, FIG. 2 illustrates a flowchart of a method for evaluating a text content according to an embodiment of the present disclosure, the flowchart 200 includes the following steps 201-204.

Step 201 includes splitting a to-be-evaluated text into a plurality of clauses arranged in sequence according to punctuation information of the to-be-evaluated text.

In the present embodiment, the to-be-evaluated text is acquired by an executing body of the method for evaluating a text content (for example, the server 105 shown in FIG. 1), and the to-be-evaluated text is split according to the punctuation information such as a segment character, a comma, and a period and the like included in the to-be-evaluated text, thereby obtaining a plurality of clauses arranged in sequence.

It should be understood that an order of the clauses obtained by splitting is consistent with an order of clauses in the to-be-evaluated text, for example, the to-be-evaluated text is “Silk Washing Stream Uncaring Mild Chill Goes Upstairs of Tower”, the clauses arranged in sequence and obtained by splitting are “Silk Washing Stream” and “Uncaring Mild Chill Goes Upstairs of Tower”.

It should be noted that the to-be-evaluated text may be directly acquired by the above-mentioned executing body from a local storage device, or may be acquired from a non-local storage device (such as the terminal devices 101, 102, 103 shown in FIG. 1).

The local storage device may be a data storage module, such as a server hard disk, provided in the executing body, in which case the to-be-evaluated text can be quickly read locally. The non-local storage device may alternatively be any other electronic device provided for storing data, such as some user terminals or the like, in which case the above-mentioned executing body may acquire the desired to-be-evaluated text by transmitting an acquiring command to the electronic device.

In some embodiments, after the to-be-evaluated text is acquired, the to-be-evaluated text may further be preprocessed by means of data cleaning or the like, so as to remove interfering contents such as spaces and wrong punctuation marks included therein, and improve the quality of the clauses obtained after the to-be-evaluated text is split.

Step 202 includes determining the first clause of the plurality of clauses as an actual tune name.

In the present embodiment, after splitting the to-be-evaluated text into the plurality of clauses arranged in sequence based on the step 201, the first clause arranged in the first order is determined as the actual tune name.

Further, in the process of determining the first clause as an actual tune name, the first clause may be initially screened by acquiring the character count of the first clause.

When the difference between the character count of the first clause and the character count of the allowed tune name exceeds the confidence threshold, it is determined that the first clause cannot be used as an actual tune name, and the to-be-evaluated text is evaluated as a non-Ci-poetry text.

Step 203 includes determining actual prosodic information based on a Chinese phonetic alphabet text of the third clause to the last clause, in response to determining that a number of clauses, whose numbers of Chinese characters satisfy character count requirements of clauses corresponding to the actual tune name, from the third clause to the last clause exceeds a number threshold.

In the present embodiment, after the actual tune name is determined in the step 202, the numbers of Chinese characters of the clauses corresponding to the actual tune name is acquired, and after the number of Chinese characters of each clause from the third clause in the third order to the last clause in the last order is acquired, the number of Chinese characters of each clause from the third clause to the last clause is compared with the number of Chinese characters of each clause corresponding to the actual tune name, so as to determine the number of clauses whose numbers of Chinese characters satisfy character count requirements of clauses corresponding to the actual tune name, and when it is determined that the number of clauses whose numbers of Chinese characters satisfy character count requirements of clauses corresponding to the actual tune name exceeds the number threshold, the actual prosodic information is determined based on the Chinese phonetic alphabet and vowel in the Chinese phonetic alphabet text of the third clause to the last clause.

The numbers of Chinese characters of the clauses corresponding to the actual tune name are usually determined based on the character count rule to be satisfied when the tune name is used. For example, when it is determined that the tune name is “Silk Washing Stream” (song name of imperial music office in Tang Xuanzong period, which is later used as a Ci-poetry tone), based on the character count rule of “42 Chinese characters with standardized form in two parts, three clauses in the upper part with three level tones, and three clauses in the lower part with two level tones” required by the tune name, the number of Chinese characters of each clause from the third clause to the last clause is determined to be 6. It should be understood that there are many different character count rules in the same actual tune name based on variations and other reasons.

Further, in some embodiments, the corresponding number of clauses may also be set according to the tune name, and whether the number of clauses from the third clause to the last clause satisfies the clause number rule corresponding to the actual tune name is used to help determine whether it is necessary to perform the step of determining actual prosodic information based on a Chinese phonetic alphabet text of the third clause to the last clause.

Furthermore, in some embodiments, when the actual tune name determined in the step 202 above are not the “allowed tune name”, it may be configured that the character count requirements corresponding to the tune name is determined according to the character count information of the actual tune name.

Step 204 includes in response to the actual prosodic information being consistent with a standard prosodic information of the actual tune name, evaluating the to-be-evaluated text as a Ci-poetry text.

In the present embodiment, the standard prosodic information corresponding to the actual tune name is obtained, and after the allowed tune name is obtained, the standard prosodic information corresponding to the actual tune name may also be determined based on the prosodic information to be satisfied when the allowed tune name is used. Similarly, there may be a plurality of different standard prosodic information in the same actual tune name based on a variant or the like, for example, when the tune name is determined to be “Silk Washing Stream”, the standard prosodic information of “standardized form in two parts, three clauses in the upper part with three level tones, and three clauses in the lower part with two level tones” is determined based on the required prosodic information “42 Chinese characters with standardized form in two parts, three clauses in the upper part with three level tones, and three clauses in the lower part with two level tones”. After the actual prosodic information is generated based on the step 203 of determining actual prosodic information based on a Chinese phonetic alphabet text of the third clause to the last clause, a response is made when the actual prosodic information is consistent with the standard prosodic information, that is, a response is made when it is determined that the actual prosodic information is the same as the standard prosodic information and that the actual prosodic information satisfies the requirement of the standard prosodic information, and the to-be-evaluated text is evaluated as a Ci-poetry text to realize the evaluation of the to-be-evaluated text.

According to the method for evaluating a text content provided by the embodiment of the present disclosure, after the to-be-evaluated text is split, information that exists in the to-be-evaluated text and is used as the tune name is determined, and prosody matching is performed on the to-be-evaluated text by using standard prosodic information corresponding to the actual tune name, to implement the evaluation of the to-be-evaluated text, so that a user can know whether the to-be-evaluated text satisfies the Ci-poetry text requirement.

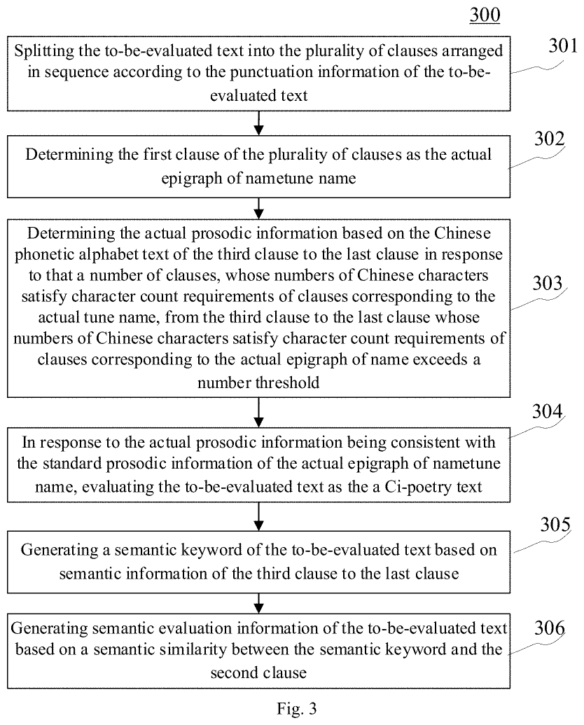

Referring to FIG. 3, FIG. 3 is a flowchart of another method for evaluating a text content according to an embodiment of the present disclosure, the flowchart 300 includes the following steps 301-306.

Step 301 includes splitting the to-be-evaluated text into the plurality of clauses arranged in sequence according to the punctuation information of the to-be-evaluated text.

Step 302 includes determining the first clause of the plurality of clauses as an actual tune name.

Step 303 includes determining the actual prosodic information based on the Chinese phonetic alphabet text of the third clause to the last clause, in response to determining that a number of clauses, whose numbers of Chinese characters satisfy character count requirements of clauses corresponding to the actual tune name, from the third clause to the last clause exceeds a number threshold.

Step 304 includes in response to the actual prosodic information being consistent with the standard prosodic information of the actual tune name, evaluating the to-be-evaluated text as the Ci-poetry text.

Step 305 includes generating a semantic keyword of the to-be-evaluated text based on semantic information of the third clause to the last clause.

In the present embodiment, after the third clause to the last clause are acquired, the third clause to the last clause are spliced. Semantic analysis is performed based on the spliced result, and the semantic information of the third clause to the last clause is generated. A corresponding semantic keyword is determined based on the semantic information, and the semantic keyword is used as a semantic keyword of the to-be-evaluated text.

In some embodiments, the method may further include: after the semantic information corresponding to the clauses from the third clause to the last clause is generated, the acquired multiple pieces of semantic information may be summarized and feature analyzing is performed thereon to generate the semantic information of the third clause to the last clause.

Step 306 includes generating semantic evaluation information of the to-be-evaluated text based on a semantic similarity between the semantic keyword and the second clause.

In the present embodiment, after the semantic information of the second clause in the second order is acquired, the similarity between the semantic information and the semantic keyword of the to-be-evaluated text determined in the above step 305 is acquired, and the semantic evaluation information of the to-be-evaluated text is generated. The semantic evaluation information may directly include the similarity between the semantic keyword and the second clause, or the semantic evaluation information may be generated based on the evaluation level, where the evaluation level may be determined according to different value intervals in which the similarity falls. For example, when it is determined that the similarity is 60%, the semantic evaluation information is generated based on the value intervals in which the similarity falls (high quality: 80%<similarity ≤100%; common quality: 70%<similarity ≤80%; Low quality: 50%<similarity ≤70%).

The above steps 301-304 are consistent with the steps 201-204 shown in FIG. 2. For contents of the same part, reference may be made to the corresponding part of the previous embodiment, and details are not described herein. On the basis of the embodiment shown in FIG. 2, the present embodiment may further include: determining a subject of the Ci-poetry text based on the second clause used to embody the subject, and then comparing the similarity between the subject of the Ci-poetry text and the subject determined based on the third clause to the last clause, so as to determine the semantic consistency of the contents in the to-be-evaluated text (the Ci-poetry text), thereby realizing the evaluation of the quality of the Ci-poetry text at the semantic level.

In some alternative implementations of the present embodiment, the generating the semantic keyword of the to-be-evaluated text based on the semantic information of the third clause to the last clause includes: acquiring reference semantic keywords corresponding to the clauses from the third clause to the last clause, respectively; and in response to that a proportion of reference semantic keywords which are classifiable as a same semantic keyword exceeds a proportion threshold, determining the same semantic keyword as the semantic keyword of the to-be-evaluated text.

Specifically, after the reference semantic keywords corresponding to the clauses from the third clause to the last clause are respectively acquired, the content of each reference semantic keyword is counted, when the proportion of the reference semantic keywords which can be classified as the same semantic keyword exceeds the proportion threshold, a response is made. The same semantic keyword of the reference semantic keywords that is used to characterize the proportion exceeding the proportion threshold is determined as the semantic keyword of the to-be-evaluated text, so that the semantic keyword of the to-be-evaluated text is generated by clustering the semantic keywords of the clauses, and the quality of the semantic keyword of the to-be-evaluated text is prevented from being affected by deviation of the semantic information of a few clauses.

In some alternative implementations of the present embodiment, the method for evaluating a text content further includes: generating semantic optimization indication information based on reference semantic keywords which are unclassifiable as the same semantic keyword.

Specifically, in the process of generating the semantic keyword of the to-be-evaluated text by clustering method, the reference semantic keyword that are unclassifiable as the same semantic keyword may also be acquired, and the semantic optimization indication information is generated based on the reference semantic keyword that are unclassifiable as the same semantic keyword, so as to adjust the clause with lower semantic quality in the to-be-evaluated text according to the semantic optimization indication information, thereby improving quality of the Ci-poetry text.

On the basis of any one of the above embodiments, the method for evaluating a text content further includes: determining the to-be-evaluated text as a low quality Ci-poetry text in response to that the similarity between the actual prosodic information and the standard prosodic information of the actual tune name falls within a confidence interval.

Specifically, the confidence interval of the similarity of the prosodic information may also be set so as to respond when the similarity between the actual prosodic information and the standard prosodic information of the actual tune name falls within the confidence interval, and the to-be-evaluated text is determined as the Ci-poetry text, so as to avoid that the to-be-evaluated text cannot be recognized as the Ci-poetry text due to some prosodic errors, and improve compatibility of the method for evaluating a text content.

Further, in order to facilitate optimization of the to-be-evaluated text and the Ci-poetry text and improve the quality of the Ci-poetry text, when it is determined that the Ci-poetry text is a low quality Ci-poetry text due to prosodic information, it is also possible to indicate the part of to be optimized content in the Ci-poetry text. Therefore, in some embodiments, the method for evaluating a text content further includes: extracting difference information between the actual prosodic information and the standard prosodic information, and determining a difference Chinese phonetic alphabet text based on the difference information; and generating prosodic optimization indication information based on the difference Chinese phonetic alphabet text.

Specifically, the difference information between the actual prosodic information and the standard prosodic information is extracted, and the difference Chinese phonetic alphabet text is determined based on the difference information. Then the prosodic optimization indication information is generated based on the difference Chinese phonetic alphabet text. The prosodic optimization indication information preferably includes a clause corresponding to the difference Chinese phonetic alphabet text and the standard prosodic information of the clause corresponding to the difference Chinese phonetic alphabet text in the standard prosodic information corresponding to the actual tune name, so as to adjust the difference Chinese phonetic alphabet text based on the standard prosodic information.

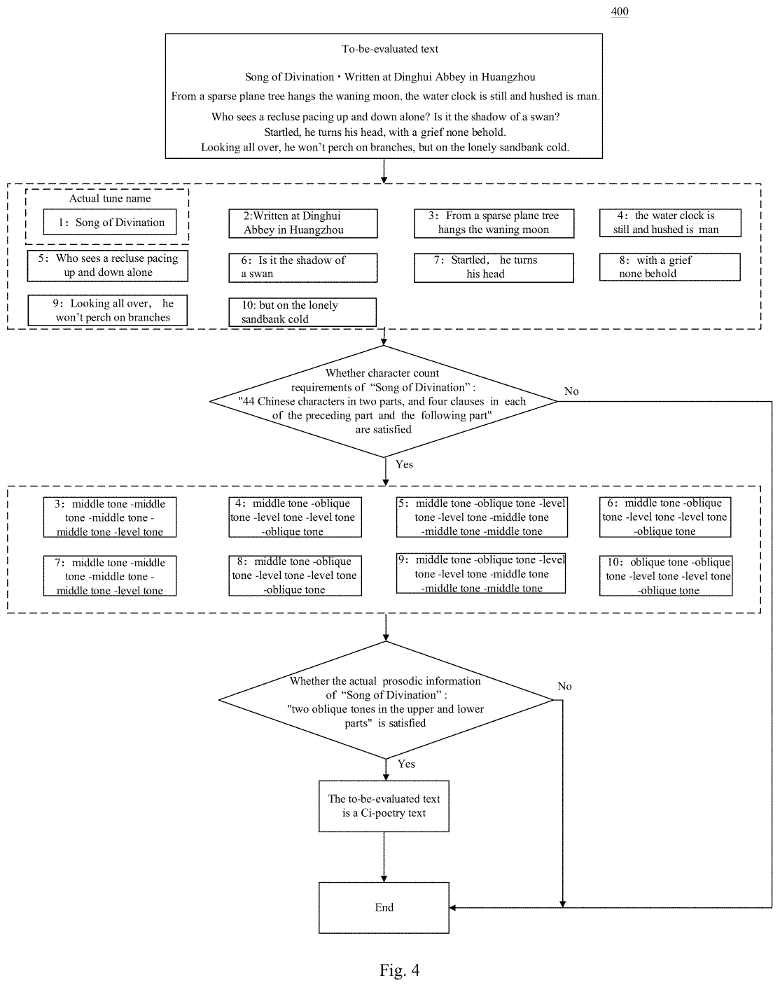

For further understanding, the present disclosure also provides a specific implementation in conjunction with a specific application scenario. Please refer to a flow 400 shown in FIG. 4.

The to-be-evaluated text “Song of Divination Written at Dinghui Abbey in Huangzhou. From a sparse plane tree hangs the waning moon, the water clock is still and hushed is man. Who sees a recluse pacing up and down alone? Is it the shadow of a swan? Startled, he turns his head, with a grief none behold. Looking all over, he won't perch on branches, but on the lonely sandbank cold.” is obtained, then, according to the punctuation information of the to-be-evaluated text, the to-be-evaluated text is split into a plurality of clauses arranged in sequence: “Song of Divination”, “Written at Dinghui Abbey in Huangzhou”, “From a sparse plane tree hangs the waning moon”, “the water clock is still and hushed is man”, “Who sees a recluse pacing up and down alone”, “Is it the shadow of a swan”, “Startled, he turns his head”, “with a grief none behold”, “Looking all over, he won't perch on branches”, and “but on the lonely sandbank cold”.

The first clause “Song of Divination” is determined as the actual tune name, and after acquiring character count requirements of clauses corresponding to the actual tune name “44 Chinese characters in two parts, and four clauses in each of the preceding part and the following part”, it is determined that there are eight clauses from the third clause to the last clause, a total of 44 Chinese characters, which satisfy the character count requirements of “44 Chinese characters in two parts, and four clauses in each of the preceding part and the following part”. The number of clauses is 8, which exceeds the number threshold (6). Based on the Chinese phonetic alphabet text corresponding to “from a sparse plane tree hangs the waning moon”, “the water clock is still and hushed is man”, “who sees a recluse pacing up and down alone”, “is it the shadow of a swan”, “startled, he turns his head”, “with a grief none behold”, “looking all over, he won't perch on branches”, and “but on the lonely sandbank cold”, the actual prosodic information is determined to be “middle tone—middle tone—middle tone—middle tone—level tone”, “middle tone—oblique tone—level tone—level tone—oblique tone”, “middle tone—oblique tone—level tone—level tone—middle tone—middle tone—middle tone”, “middle tone—oblique tone—level tone—level tone—oblique tone”, “middle tone—middle tone—middle tone—middle tone—level tone”, “middle tone—oblique tone—level tone—level tone—oblique tone”, “middle tone—oblique tone—level tone—level tone—middle tone—middle tone—middle tone”, and “oblique tone—oblique tone—level tone—level tone—oblique tone”.

The standard prosodic information corresponding to the actual tune name is “two oblique tones in the upper part and two oblique tones in the lower part”, it is determined that the actual prosodic information of the to-be-evaluated text is consistent with the standard prosodic information, and it is determined that the to-be-evaluated text is evaluated as the Ci-poetry text.

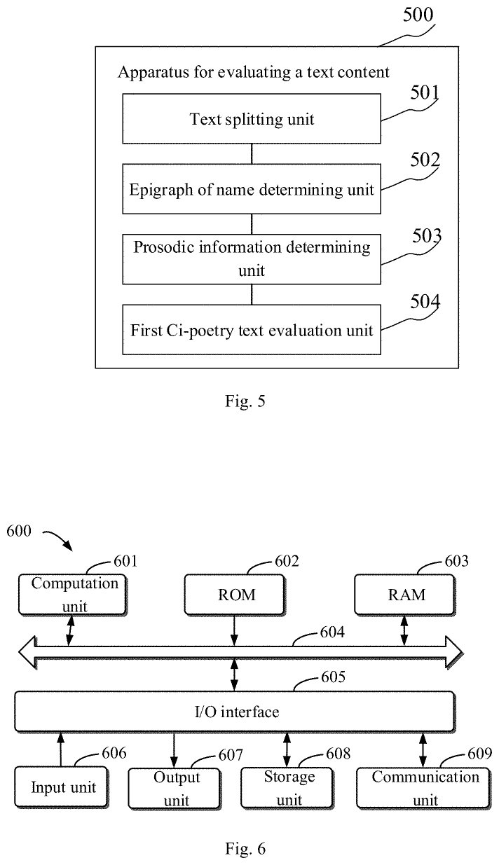

With further reference to FIG. 5, as an implementation of the method shown in each of the above figures, the present disclosure provides an embodiment of an apparatus for evaluating a text content, which corresponds to the method embodiment shown in FIG. 2 and is particularly applicable to various electronic devices.

As shown in FIG. 5, the apparatus 500 for evaluating a text content of the present embodiment may include: a text splitting unit 501, a tune name determining unit 502, a prosodic information determining unit 503, and a first Ci-poetry text evaluation unit 504. The text splitting unit 501 is configured to split a to-be-evaluated text into a plurality of clauses arranged in sequence according to punctuation information of the to-be-evaluated text; the tune name determining unit 502 is configured to determine a first clause of the plurality of clauses as an actual tune name; the prosodic information determining unit 503, is configured to determine actual prosodic information based on a Chinese phonetic alphabet text of a third clause to a last clause in response to that a number of clauses, whose numbers of Chinese characters satisfy character count requirements of clauses corresponding to the actual tune name, from the third clause to the last clause exceeds a number threshold; and the first Ci-poetry text evaluation unit 504 is configured to, in response to the actual prosodic information being consistent with a standard prosodic information of the actual tune name, evaluate the to-be-evaluated text as a Ci-poetry text.

In the present embodiment, in the apparatus 500 for evaluating a text content, the specific processing and the technical effects of the text splitting unit 501, the tune name determining unit 502, the prosodic information determining unit 503, and the Ci-poetry text first evaluation unit 504 may be described with reference to the related description of steps 201-204 in the corresponding embodiment in FIG. 2, and details are not described herein.

In some alternative implementations of the present embodiment, the apparatus 500 for evaluating a text content further includes: a semantic keyword generating unit, configured to generate a semantic keyword of the to-be-evaluated text based on semantic information of the third clause to the last clause; and a semantic evaluation information generating unit, configured to generate semantic evaluation information of the to-be-evaluated text based on a semantic similarity between the semantic keyword and a second clause.

In some alternative implementations of the present embodiment, the semantic keyword generating unit includes: a reference keyword acquiring subunit, configured to acquire reference semantic keywords corresponding to the clauses from the third clause to the last clause, respectively; and a semantic keyword determining subunit, configured to, in response to that a proportion of reference semantic keywords which are classifiable as a same semantic keyword exceeds a proportion threshold, determining the same semantic keyword as the semantic keyword of the to-be-evaluated text.

In some alternative implementations of the present embodiment, the apparatus 500 for evaluating a text content further includes: a semantic optimization information generating unit configured to generate semantic optimization indication information based on reference semantic keywords which are unclassifiable as the same semantic keyword.

In some alternative implementations of the present embodiment, the apparatus 500 for evaluating a text content further includes: a second Ci-poetry text evaluation unit configured to determine the to-be-evaluated text as a low quality Ci-poetry text in response to that the similarity between the actual prosodic information and the standard prosodic information of the actual tune name falls within a confidence interval.

In some alternative implementations of the present embodiment, the apparatus 500 for evaluating a text content further includes: a difference Chinese phonetic alphabet text determining unit configured to extract difference information between the actual prosodic information and the standard prosodic information, and determine a difference Chinese phonetic alphabet text based on the difference information; and a prosodic optimization information generating unit configured to generate prosodic optimization indication information based on the difference Chinese phonetic alphabet text.

The present embodiment is an apparatus embodiment corresponding to the above-described method embodiment. After the to-be-evaluated text is split, information that exists in the to-be-evaluated text and is used as the tune name is determined, and prosody matching is performed on the to-be-evaluated text by using standard prosodic information corresponding to the actual tune name, to realize the evaluation of the to-be-evaluated text, so that a user can know whether the to-be-evaluated text satisfies the Ci-poetry text requirement.

According to an embodiment of the present disclosure, the present disclosure further provides an electronic device, a readable storage medium, and a computer program product.

FIG. 6 illustrates a schematic block diagram of an example electronic device 600 that may be used to implement embodiments of the present disclosure. The electronic device is intended to represent various forms of digital computers, such as laptop computers, desktop computers, workbenches, personal digital assistants, servers, blade servers, mainframe computers, and other suitable computers. The electronic device may also represent various forms of mobile apparatuses, such as personal digital processors, cellular phones, smart phones, wearable devices, and other similar computing apparatuses. The components shown herein, their connections and relationships, and their functions are merely examples, and are not intended to limit the implementation of the present disclosure described and/or claimed herein.

As shown in FIG. 6, The electronic device 600 includes a computation unit 601, which may perform various appropriate actions and processing, based on a computer program stored in a read-only memory (ROM) 602 or a computer program loaded from a storage unit 608 into a random access memory (RAM) 603. In the RAM 603, various programs and data required for the operation of the device 600 may also be stored. The computation unit 601, the ROM 602, and the RAM 603 are connected to each other through a bus 604. An input/output (I/O) interface 605 is also connected to the bus 604.

A plurality of parts in the device 600 are connected to the I/O interface 605, including: an input unit 606, for example, a keyboard and a mouse; an output unit 607, for example, various types of displays and speakers; the storage unit 608, for example, a disk and an optical disk; and a communication unit 609, for example, a network card, a modem, or a wireless communication transceiver. The communication unit 609 allows the device 600 to exchange information/data with other devices over a computer network such as the Internet and/or various telecommunication networks.

The computation unit 601 may be various general-purpose and/or dedicated processing components having processing and computing capabilities. Some examples of the computation unit 601 include, but are not limited to, central processing unit (CPU), graphics processing unit (GPU), various dedicated artificial intelligence (AI) computing chips, various computation units running machine learning model algorithms, digital signal processors (DSP), and any appropriate processors, controllers, microcontrollers, etc. The computation unit 601 performs the various methods and processes described above, such as the method for evaluating a text content. For example, in some embodiments, the method for evaluating a text content may be implemented as a computer software program, which is tangibly included in a machine readable medium, such as the storage unit 608. In some embodiments, part or all of the computer program may be loaded and/or installed on the device 600 via the ROM 602 and/or the communication unit 609. When the computer program is loaded into the RAM 603 and executed by the computation unit 601, one or more steps of the method for evaluating a text content described above may be performed. Alternatively, in other embodiments, the computation unit 601 may be configured to perform the method for evaluating a text content by any other appropriate means (for example, by means of firmware).

Various implementations of the systems and technologies described above herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), computer hardware, firmware, software, and/or a combination thereof. The various implementations may include: an implementation in one or more computer programs that are executable and/or interpretable on a programmable system including at least one programmable processor, which may be a special-purpose or general-purpose programmable processor, and may receive data and instructions from, and transmit data and instructions to, a storage system, at least one input apparatus, and at least one output device.

Program codes for implementing the method of the present disclosure may be compiled using any combination of one or more programming languages. The program codes may be provided to a processor or controller of a general-purpose computer, a special-purpose computer, or other programmable apparatuses for processing vehicle-road collaboration information, such that the program codes, when executed by the processor or controller, cause the functions/operations specified in the flow charts and/or block diagrams to be implemented. The program codes may be completely executed on a machine, partially executed on a machine, executed as a separate software package on a machine and partially executed on a remote machine, or completely executed on a remote machine or server.

In the context of the present disclosure, the machine-readable medium may be a tangible medium which may contain or store a program for use by, or used in combination with, an instruction execution system, apparatus or device. The machine-readable medium may be a machine-readable signal medium or a machine-readable storage medium. The machine-readable medium may include, but is not limited to, electronic, magnetic, optical, electromagnetic, infrared, or semiconductor systems, apparatuses, or devices, or any appropriate combination of the above. A more specific example of the machine-readable storage medium will include an electrical connection based on one or more pieces of wire, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, an optical storage device, a magnetic storage device, or any appropriate combination of the above.

To provide interaction with a user, the systems and technologies described herein may be implemented on a computer that is provided with: a display apparatus (e.g., a CRT (cathode ray tube) or a LCD (liquid crystal display) monitor) configured to display information to the user; and a keyboard and a pointing apparatus (e.g., a mouse or a trackball) by which the user can provide an input to the computer. Other kinds of apparatuses may also be configured to provide interaction with the user. For example, feedback provided to the user may be any form of sensory feedback (e.g., visual feedback, auditory feedback, or haptic feedback); and an input may be received from the user in any form (including an acoustic input, a voice input, or a tactile input).

The systems and technologies described herein may be implemented in a computing system (e.g., as a data server) that includes a back-end component, or a computing system (e.g., an application server) that includes a middleware component, or a computing system (e.g., a user computer with a graphical user interface or a web browser through which the user can interact with an implementation of the systems and technologies described herein) that includes a front-end component, or a computing system that includes any combination of such a back-end component, such a middleware component, or such a front-end component. The components of the system may be interconnected by digital data communication (e.g., a communication network) in any form or medium. Examples of the communication network include: a local area network (LAN), a wide area network (WAN), and the Internet.

The computer system may include a client and a server. The client and the server are generally remote from each other, and usually interact via a communication network. The relationship between the client and the server arises by virtue of computer programs that run on corresponding computers and have a client-server relationship with each other. The server may be a cloud server, also known as a cloud computing server or a cloud host, which is a host product in the cloud computing service system to solve the defects of large management difficulties and weak business expansion in traditional physical host and virtual private server (VPS, Virtual Private Server) services. The server may also be a distributed system server, or a server combined with a blockchain.

According to the method for evaluating a text content provided by the embodiment of the present invention, after the to-be-evaluated text is split, information that exists in the to-be-evaluated text and is used as the tune name is determined, and prosodic matching is performed on the to-be-evaluated text by using standard prosodic information corresponding to the actual tune name, to realize the evaluation of the to-be-evaluated text, so that a user can know whether the to-be-evaluated text satisfies the Ci-poetry text requirement.

It should be understood that the various forms of processes shown above may be used to reorder, add, or delete steps. For example, the steps disclosed in the present disclosure may be executed in parallel, sequentially, or in different orders, as long as the desired results of the technical solutions disclosed in the present disclosure can be implemented. This is not limited herein.

The above specific implementations do not constitute any limitation to the scope of protection of the present disclosure. It should be understood by those skilled in the art that various modifications, combinations, sub-combinations, and replacements may be made according to the design requirements and other factors. Any modification, equivalent replacement, improvement, and the like made within the spirit and principle of the present disclosure should be encompassed within the scope of protection of the present disclosure.

What is claimed is:

1. A method for evaluating a text content, comprising:
splitting a to-be-evaluated text into a plurality of clauses arranged in a sequence according to punctuation information of the to-be-evaluated text;
determining that a first clause of the plurality of clauses is an actual tune name;
determining actual prosodic information based on a Chinese phonetic alphabet text of a third clause to a last clause, in response to determining that a number of clauses, whose numbers of Chinese characters satisfy character count requirements of clauses corresponding to the actual tune name, from the third clause to the last clause exceeds a number threshold; and
in response to the actual prosodic information being consistent with a standard prosodic information of the actual tune name, evaluating the to-be-evaluated text as a Ci-poetry text.

2. The method according to claim 1, further comprising:
generating a semantic keyword of the to-be-evaluated text based on semantic information of the third clause to the last clause; and
generating semantic evaluation information of the to-be-evaluated text based on a semantic similarity between the semantic keyword and a second clause.

3. The method according to claim 2, wherein generating the semantic keyword of the to-be-evaluated text based on the semantic information of the third clause to the last clause, comprises:
acquiring reference semantic keywords corresponding to the clauses from the third clause to the last clause, respectively; and
in response to that a proportion of reference semantic keywords which are classifiable as a same semantic keyword exceeds a proportion threshold, determining the same semantic keyword as the semantic keyword of the to-be-evaluated text.

4. The method according to claim 3, further comprising:
generating semantic optimization indication information based on reference semantic keywords which are unclassifiable as the same semantic keyword.

5. The method according to claim 1, further comprising:
Determining the to-be-evaluated text is low quality Ci-poetry text responsive to a similarity between the actual prosodic information and the standard prosodic information of the actual tune name falling within a confidence interval.

6. The method according to claim 2, further comprising:
determining the to-be-evaluated text is low quality Ci-poetry text responsive to a similarity between the actual prosodic information and the standard prosodic information of the actual tune name falling within a confidence interval.

7. The method according to claim 3, further comprising:
determining the to-be-evaluated text is low quality Ci-poetry text responsive to a similarity between the actual prosodic information and the standard prosodic information of the actual tune name falling within a confidence interval.

8. The method according to claim 4, further comprising:
determining the to-be-evaluated text is low quality Ci-poetry text responsive to a similarity between the actual prosodic information and the standard prosodic information of the actual tune name falling within a confidence interval.

9. The method according to claim 5, further comprising:
extracting difference information between the actual prosodic information and the standard prosodic information, and determining a difference Chinese phonetic alphabet text based on the difference information; and
generating prosodic optimization indication information based on the difference Chinese phonetic alphabet text.

10. An electronic device, comprising:
at least one processor; and
a memory communicatively connected to the at least one processor;
wherein the memory stores instructions executable by the at least one processor to perform operations comprising:
splitting a to-be-evaluated text into a plurality of clauses arranged in sequence according to punctuation information of the to-be-evaluated text;
determining that a first clause of the plurality of clauses is an actual tune name;
determining actual prosodic information based on a Chinese phonetic alphabet text of a third clause to a last clause, in response to determining that a number of clauses, whose numbers of Chinese characters satisfy character count requirements of clauses corresponding to the actual tune name, from the third clause to the last clause exceeds a number threshold; and
in response to the actual prosodic information being consistent with a standard prosodic information of the actual tune name, evaluating the to-be-evaluated text as a Ci-poetry text.

11. The electronic device according to claim 10, wherein the operations further comprise:
generating a semantic keyword of the to-be-evaluated text based on semantic information of the third clause to the last clause; and
generating semantic evaluation information of the to-be-evaluated text based on a semantic similarity between the semantic keyword and a second clause.

12. The electronic device according to claim 11, wherein generating the semantic keyword of the to-be-evaluated text based on the semantic information of the third clause to the last clause, comprises:
acquiring reference semantic keywords corresponding to the clauses from the third clause to the last clause, respectively; and
in response to a proportion of reference semantic keywords which are classifiable as a same semantic keyword exceeding a proportion threshold, determining the same semantic keyword as the semantic keyword of the to-be-evaluated text.

13. The electronic device according to claim 12, wherein the operations further comprise:
generating semantic optimization indication information based on reference semantic keywords which are unclassifiable as the same semantic keyword.

14. The electronic device according to claim 10, wherein the operations further comprise:
determining the to-be-evaluated text is low quality Ci-poetry text responsive to a similarity between the actual prosodic information and the standard prosodic information of the actual tune name falling within a confidence interval.

15. The electronic device according to claim 11, wherein the operations further comprise:
determining the to-be-evaluated text is low quality Ci-poetry text responsive to a similarity between the actual prosodic information and the standard prosodic information of the actual tune name falling within a confidence interval.

16. The electronic device according to claim 12, wherein the operations further comprise:
determining the to-be-evaluated text is low quality Ci-poetry text responsive to a similarity between the actual prosodic information and the standard prosodic information of the actual tune name falling within a confidence interval.

17. The electronic device according to claim 13, wherein the operations further comprise:
determining the to-be-evaluated text is low quality Ci-poetry text responsive to a similarity between the actual prosodic information and the standard prosodic information of the actual tune name falling within a confidence interval.

18. The electronic device according to claim 14, wherein the operations further comprise:
extracting difference information between the actual prosodic information and the standard prosodic information, and determining a difference Chinese phonetic alphabet text based on the difference information; and
generating prosodic optimization indication information based on the difference Chinese phonetic alphabet text.

19. A non-transitory computer readable storage medium storing computer instructions, wherein the computer instructions, when executed by at least one processor, cause the at least one processor to perform operations comprising:
splitting a to-be-evaluated text into a plurality of clauses arranged in sequence according to punctuation information of the to-be-evaluated text;
determining that a first clause of the plurality of clauses is an actual tune name;
determining actual prosodic information based on a Chinese phonetic alphabet text of a third clause to a last clause, in response to determining that a number of clauses, whose numbers of Chinese characters satisfy character count requirements of clauses corresponding to the actual tune name, from the third clause to the last clause exceeds a number threshold; and
in response to the actual prosodic information being consistent with a standard prosodic information of the actual tune name, evaluating the to-be-evaluated text as a Ci-poetry text.
